(19) United States
(12) Patent Application Publication
(10) Pub. No.: US 2026/0260576 A1
(43) Pub. Date: Sep. 3, 2026

(54) ECO-FRIENDLY PAINTING SIMULATION DEVICE FOR SHIPS

(71) Applicant: KI BAEK KAM, Ulsan (KR)

(72) Inventor: KI BAEK KAM, Ulsan (KR)

(21) Appl. No.: 19/454,436

(22) Filed: Jan. 21, 2026

(30) Foreign Application Priority Data
Feb. 28, 2025 (KR) 10-2025-0026680

(51) Int. Cl. G09B 9/00

(52) U.S. Cl. CPC G09B 9/00

(57) ABSTRACT

Provided is to an eco-friendly painting simulation device for ships so as to perform simulation using an object to be painted for an actual ship other than a virtual space, use an airless spray gun actually used in ship painting, quantitatively analyze paint patterns by precisely tracking spray gun positions, reduce emissions of environmental pollutants (VOCs) to zero, and reduce costs for expensive paints and costs for paint booth operation.

### TECHNICAL FIELD

The present invention relates to an eco-friendly painting simulation device for ships, and more particularly, to an eco-friendly painting simulation device for ships to perform simulation using an object to be painted for an actual ship other than a virtual space.

### BACKGROUND ART

Ship painting is considered the most effective approach for improving the durability of a hull and the lifespan of a ship. However, the ship painting has a high level of technical difficulty, and requires numerous repetitive trainings to foster skilled technicians.

However, due to poor environments and cost issues for education, training efficiency may be lowered, and technological barriers to entry for workers may be high.

In addition, waiting time may be delayed because paint is required to be dried and defects in a coating thickness and the like are required to be checked, and continuous training may fail because it is difficult to recycle a teaching material (an object to be painted, hereinafter referred to as an 'object') having been used once.

In order to solve the above conventional problems, painting simulators utilizing VR technology and flat screens have been released around the countries.

Recently, Samsung Heavy Industries and Daewoo Shipbuilding & Marine Engineering have introduced a painting simulator using a VR goggle into a ship painting training system. However, since the simulator using the VR goggle has difficulty in checking a distance between an object and a spray gun in a virtual space, and has discrepancy from reality, many say that the simulator is closer to a game play other than professional simulation.

In addition, the VR goggle is not used much in actual training because of causing dizziness and vomiting often when worn for 10 minutes or more.

In addition, the flat screen scheme is suitable for training on a flat object, however, it may be difficult to implement a curve or three-dimensional shape of an actual object.

### DISCLOSURE

### Technical Problem

In order to solve the above conventional problems, an object of the present invention is to provide an eco-friendly painting simulation device for ships to overcome limitations of the existing VR goggle-type painting simulators.

Another object of the present invention is to provide an eco-friendly painting simulation device for ships to perform simulation using an object to be painted for an actual ship other than a virtual space.

Still another object of the present invention is to provide an eco-friendly painting simulation device for ships to use an actual airless spray gun and increase the reliability of simulation through analysis and verification of spraying.

### Technical Solution

The eco-friendly painting simulation device for ships according to the present invention to achieve the above objects includes: an object irradiated with light so as to be coated with paint color; a laser projector for projecting a laser onto the object to implement the paint color; a spray gun for specifying a position and an intensity of the light irradiated to the object; and a tracking marker for providing a reference point for tracking a position of the spray gun.

The object may be at least one selected from the group including a flat plate, a T longitudinal member, an L longitudinal member, a stiffener, a scallop, and a ship lightening hole.

The laser projector may use an ultra-short focus lens so as to project at a short distance.

The tracking marker serves as a reference point for tracking the position of the spray gun in real time, and may include at least one infrared LED.

The spray gun may include a tracking module having a tracking camera and a trigger switch.

The tracking module may measure at least one of a spraying distance, a spraying angle, a spraying speed, a discharging amount, three-dimensional position coordinates, a main air pressure, and a discharging air pressure.

### Advantageous Effects

According to the present invention, virtual paint may be displayed on an actual object to be painted for ships, so that the painting simulation can be implemented.

In addition, properties of the paint may be input, so that painting results (such as coating thickness and painting defect) can be interpreted.

In addition, the position of the spray gun may be precisely tracked, so that a painting pattern can be quantitatively analyzed.

In addition, emissions of environmental pollutants (VOCs) can be reduced to zero, and costs for expensive paints and costs for paint booth operation can be reduced.

### DESCRIPTION OF DRAWINGS

FIG. 1 is a view showing an eco-friendly painting simulation device for ships according to the present invention.

FIG. 2 is a flowchart showing a simulation process by the eco-friendly painting simulation device for ships according to the present invention.

FIG. 3 is a view showing a lightening hole for ship to serve as one of objects to be pained.

### BEST MODE

### Mode for Invention

The technology described below may be modified in various ways and has many different embodiments, and specific embodiments will be illustrated in the drawings and described in detail. However, it will be understood that the specific embodiments are not intended to limit the technology described below, and include all modifications, equivalents, or substitutes included in the spirit and scope of the technology described below.

Terms such as first, second, A and B may be used to describe various elements, but the elements are not limited by the terms and are used only to distinguish one element from another element. For example, a first element may be referred to as a second element, and similarly, the second element may also be referred to as the first element, without departing from the scope of the technology described below. The term "and/or" includes any one of a plurality of related listed items or a combination thereof.

In the terms used in the present specification, a singular expression may be understood to include a plural expression unless the context clearly indicates otherwise. The term such as "include" signifies that the incorporated feature, number, step, operation, component, part or a combination thereof are present, and does not preclude the possibility of the presence or addition of one or more other features, numbers, steps, components, parts, or combinations thereof.

Prior to the detailed description of drawings, it will be made clear that the division of components in the present specification is merely based on the main function of each component. In other words, two or more components described later may be combined into one component, or one component may be divided into two or more components based on more detailed functions. In addition, each component described later may additionally perform some or all of the functions performed by other components in addition to its own main function, and some of the main function performed by each component may be performed exclusively by other components.

In addition for performing a method or operation method, each step constituting the method may occur in a different order from the stated order unless a specific order is clearly indicated in the context. In other words, the steps may occur in the stated order, may be performed substantially simultaneously, or may be performed in the opposite order.

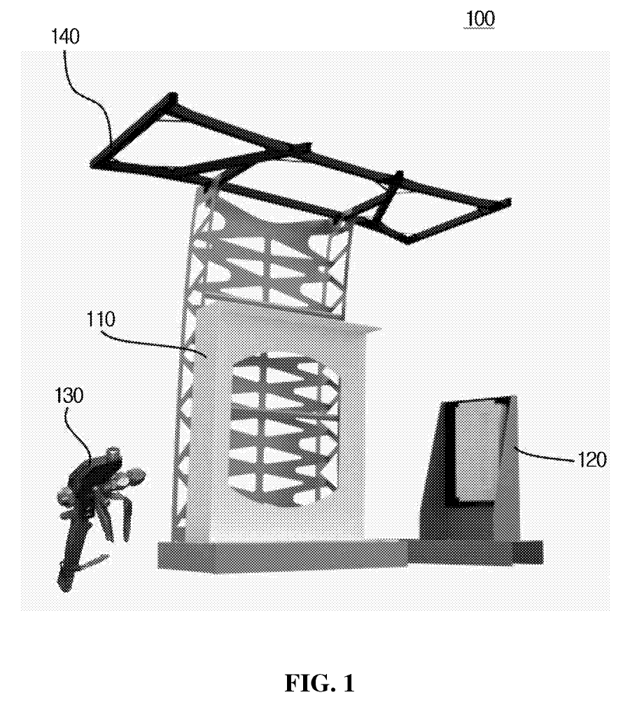

FIG. 1 is a view showing an eco-friendly painting simulation device for ships according to the present invention.

Referring to FIG. 1, an eco-friendly painting simulation device 100 for ships may include an object 110 to be painted, a laser projector 120, a spray gun 130, and a tracking marker 140.

The object 110 may be irradiated with light so as to be coated with paint color.

The object 110 may be designed in a replaceable structure to enable various modifications in one main body module.

The object 110 may be manufactured to have the same structure as an actual ship part, and processed on a surface thereof using primer paint to maintain durability against water spraying.

The object 110 may be at least one selected from the group including a T longitudinal member, an L longitudinal member, a stiffener, a scallop, and a ship lightening hole.

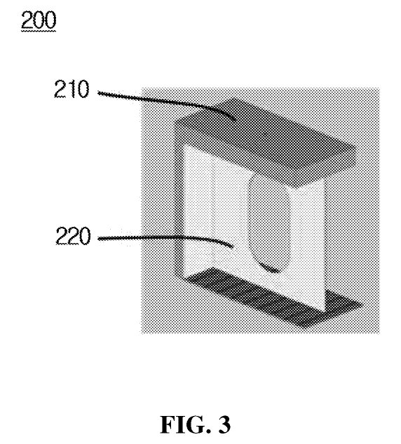

FIG. 3 shows a lightening hole for ship to serve as one of objects to be pained.

Referring to FIG. 3, the ship lightening hole 220 refers to a structure designed to reduce the weight while maintaining the rigidity of a ship member. The ship lightening hole 220 is mounted on a painting simulation work holder 210 and then irradiated with light so as to be coated with paint color.

The laser projector 120 may implement the paint color by projecting a laser onto the object 100. The laser projector 120 may use an ultra-short focus lens so as to project at a short distance.

The spray gun 130 may designate a position and an intensity of the light irradiated to the object 110. The spray gun 130 may include a tracking module having a tracking camera and a trigger switch.

The tracking module may measure at least one of a spraying distance, a spraying angle, a spraying speed, a discharging amount, three-dimensional position coordinates, a main air pressure, and a discharging air pressure.

The tracking marker 140 may provide a reference point for tracking a position of the spray gun 130.

The tracking marker 140 serves as a reference point for tracking the position of the spray gun 130 in real time, and may include at least one infrared LED.

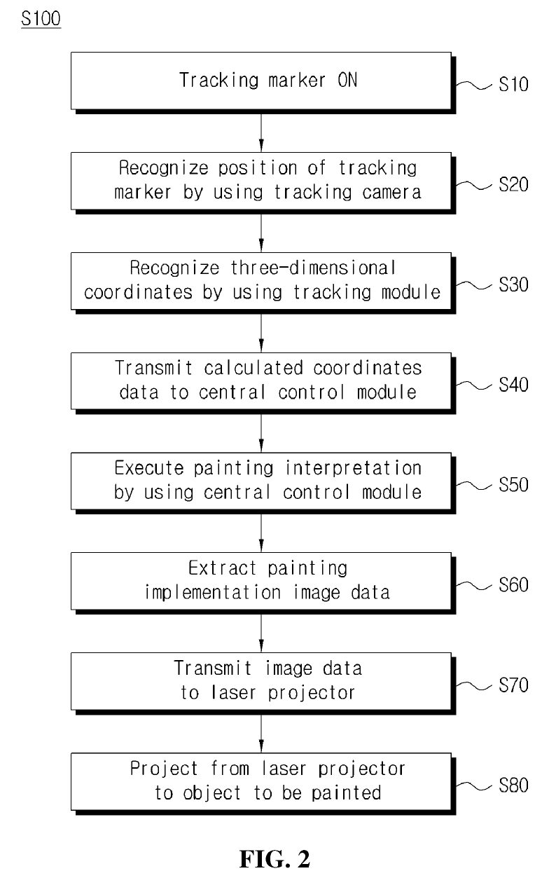

FIG. 2 is a flowchart showing a simulation process by the eco-friendly painting simulation device for ships according to the present invention.

Referring to FIG. 2, the simulation process S100 by the eco-friendly painting simulation device for ships is as follows: When a tracking marker is in a state ON (S10), a tracking camera recognizes a position of the tracking marker (S20).

The tracking module recognizes three-dimensional coordinates of the tracking marker (S30).

The three-dimensional coordinates of the tracking marker are absolute coordinates. The conventional relative coordinates scheme requires zero point adjustments in coordinates of an object to be painted and a spray gun during an initialization process, however, the absolute coordinates scheme according to the present invention may omit the zero point adjustment.

Thereafter, calculated coordinates data is transmitted to a central control module (S40).

The central control module receives the coordinates data and executes interpretation of painting based on the received coordinates data (S50). At this moment, painting implementation image data is extracted (S60), and the painting implementation image data is transmitted to a laser projector (S70).

The laser projector having received the painting implementation image data projects onto the object (S80).

The painting simulation operation is performed on the object for ship via the above processes, and accordingly, a ship painting worker may practice ship painting work that is technically highly challenging.

Through the ship painting training using the eco-friendly painting simulation device for ships according to the present invention, skilled ship painting technicians can be trained, and the emissions of environmental pollutants can be reduced to zero because actual paint is not used.

The embodiments of the present invention have been described, but a person having ordinary skill in the art may modify and change the present invention in various ways by adding, modifying or deleting elements within the scope without departing from the idea of the present invention described in the claims, and this will also be considered to be included within the scope of the rights of the present invention.

### REFERENCE NUMERALS

100: Simulation device 110: Object to be painted

120: Laser projector 130: Spray gun

140: Tracking marker

1. An eco-friendly painting simulation device for ships, the eco-friendly painting simulation device comprising:
an object irradiated with light so as to be coated with paint color;
a laser projector for projecting a laser onto the object to implement the paint color;
a spray gun for specifying a position and an intensity of the light irradiated to the object; and
a tracking marker for providing a reference point for tracking a position of the spray gun.

2. The eco-friendly painting simulation device of claim 1, wherein the object includes at least one selected from the group including a flat plate, a T longitudinal member, an L longitudinal member, a stiffener, a scallop, and a ship lightening hole.

3. The eco-friendly painting simulation device of claim 1, wherein the laser projector uses an ultra-short focus lens so as to project at a short distance.

4. The eco-friendly painting simulation device of claim 1, wherein the tracking marker serves as a reference point for tracking the position of the spray gun in real time, and includes at least one infrared LED.

5. The eco-friendly painting simulation device of claim 1, wherein the spray gun includes a tracking module having a tracking camera and a trigger switch.

6. The eco-friendly painting simulation device of claim 5, wherein the tracking module measures at least one of a spraying distance, a spraying angle, a spraying speed, a discharging amount, three-dimensional position coordinates, a main air pressure, and a discharging air pressure.
